(19) United States
(12) Patent Application Publication
(10) Pub. No.: US 2026/0258305 A1
(43) Pub. Date: Sep. 3, 2026

(54) ACIDIZED CARBON BLACK PROCESS FOR ACIDIZED ACTIVATION OF CARBON BLACK FOR REMOVAL OF POLYCYCLIC AROMATIC HYDROCARBONS FROM CRUDE OIL FEED

(71) Applicant: Saudi Arabian Oil Company, Dhahran (SA)

(72) Inventors: Zainab A. Aithan, Dammam (SA); Mohammed A. Alkhunaizi, Dhahran (SA); Emad N. Al-Shafei, Saihat (SA); Nadrah A. Alawani, Al-Qatif (SA); Wala A. Algozeeb, Dhahran (SA)

(73) Assignee: Saudi Arabian Oil Company, Dhahran (SA)

(21) Appl. No.: 19/068,597

(22) Filed: Mar. 3, 2025

(51) Int. Cl. C10G 25/00; C09C 1/56

(52) U.S. Cl. CPC C10G 25/003; C09C 1/56; C01P 2002/82; C01P 2006/12; C10G 2300/1033; C10G 2300/201

(57) ABSTRACT

A process for removing polycyclic aromatic hydrocarbons from a crude oil feed is disclosed. The process for removing polycyclic aromatic hydrocarbons comprises contacting carbon black with an acidic solution to produce acidized carbon black. The acidic solution comprises water and one or both of nitric acid or phosphoric acid. The process additionally comprises contacting the acidic treated carbon black with nitrogen in an adsorption vessel and heating the adsorption vessel to 120 to 500° C., thereby producing activated carbon black. The process further comprises removing the polycyclic aromatic hydrocarbons from the crude oil feed by contacting the activated carbon black with the crude oil feed in the adsorption vessel.

### TECHNICAL FIELD

Embodiments of the present disclosure relate to a process for treating carbon black with an acidic solution to produce an acidized carbon black for removing polycyclic aromatic hydrocarbons from a crude oil feed.

### BACKGROUND

Crude oil can contain polycyclic aromatic hydrocarbons (PAHs) and complex PAH molecules-heavy polynuclear aromatics (HPNAs) in an oil source and can be further produced during the refining process. For example, hydroprocessing may produce problematic HPNAs. High concentrations of PAHs can impact the quality and safety of derivative products. In particular, PAHs are stable and difficult to crack, and they can accumulate in recycle streams, reducing the potential yield from a crude oil feed. One method of reducing the concentration of PAHs in a crude oil feed is bleeding a portion of the effluent prior to recycling the stream. However, this limits the potential yield from an oil source.

### SUMMARY

Activated carbon sorbents are used to remove PAHs from crude oil feeds due to its adsorption properties. However, there is a continual need for increased efficacy of removal of PAHs, especially HPNAs. This need is addressed by acid activating carbon to increase the surface area and pore sizes of the carbon, and thus, greatly improving the PAH removal from crude oil feeds. Acidic activation of mesoporous carbon black significantly improves the HPNA adsorption capacity, increasing the adsorption bed lifetime over existing technologies. Additionally, the incorporation of carbon black offers a more cost-effective and environmentally friendly approach since it is produced from recycled material.

The present disclosure is directed to processes and acidized carbon black for removing polycyclic aromatic hydrocarbons from crude oil feeds. The processes of the present disclosure include contacting carbon black with an acidic solution, activating the acidized carbon black, and contacting the activated carbon black with the crude oil feed to remove the polycyclic aromatic hydrocarbons. The activated carbon black can have a mesopore surface area of greater than or equal to 1100 m²/g, a micropore surface area of less than or equal to 200 m²/g, and a total surface area greater than or equal to 1200 m²/g. Acidized and activated carbon black can remove a greater amount of polycyclic aromatic hydrocarbons than carbon black or activated carbon can.

According to at least one aspect of the present disclosure, a process for removing polycyclic aromatic hydrocarbons from a crude oil feed is disclosed. The process comprises contacting carbon black with an acidic solution to produce acidized carbon black. The acidic solution includes water and one or both of nitric acid or phosphoric acid. The process additionally comprises activating the acidic treated carbon black by contacting it with nitrogen in an adsorption vessel and heating the adsorption vessel to 120 to 500° C., producing activated carbon black. The process further comprises removing the polycyclic aromatic hydrocarbons from the crude oil feed by contacting the activated carbon black with the crude oil feed in the adsorption vessel.

Additional features and advantages of the aspects of the present disclosure will be set forth in the detailed description that follows and, in part, will be readily apparent to a person of ordinary skill in the art from the detailed description or recognized by practicing the aspects of the present disclosure.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a generalized flow diagram of an adsorption vessel for treating carbon black with an acidic solution in situ, according to one or more aspects of the present disclosure.

FIG. 2 schematically depicts a generalized flow diagram of an adsorption vessel for treating carbon black with an acidic solution ex situ, according to one or more aspects of the present disclosure.

FIG. 3 graphically depicts the Fourier-transform infrared spectra of carbon black and acidized carbon black, according to one or more aspects of the present disclosure.

FIG. 4 graphically depicts the percentage of polycyclic aromatic hydrocarbons removed from a crude oil feed when using different carbon blacks, according to one or more aspects of the present disclosure.

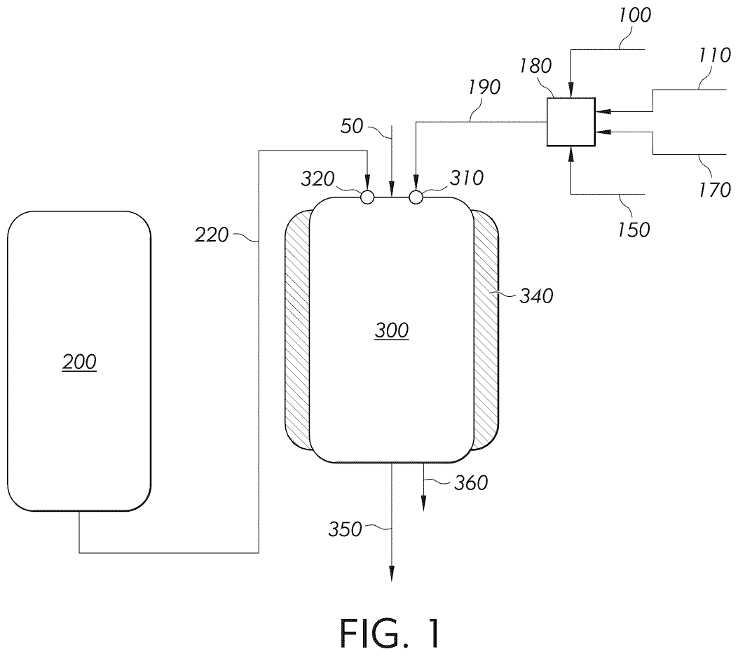

For the purpose of describing the simplified schematic illustrations and descriptions of FIG. 1-4, some of the numerous valves, temperature sensors, electronic controllers, and the like that may be employed and well known to those of ordinary skill in the art of certain chemical processing operations may not be included. Further, accompanying components that are often included in chemical processing operations, such as, for example, air supplies, heat exchangers, surge tanks, catalyst hoppers, or other related systems may not be depicted. It would be known that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines that may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows that do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

### Definitions

As used herein, “polycyclic aromatic hydrocarbons” (PAHs) are compounds that have two or more fused aromatic rings, such as anthracene.

As used herein, “heavy polynuclear aromatics” (HPNAs) refer to compounds with seven or more fused aromatic rings and often refer to compounds with eleven or more fused aromatic rings

As used herein, “carbon black” is an industrially manufactured colloidal carbon material in the form of spheres and of their fused aggregates with sizes below 1000 nm as defined by the International Union of Pure and Applied Chemistry (IUPAC). Carbon black, which encompasses subspecies acetylene black, channel black, furnace black, lamp black and thermal black, is of mineral origin (e.g., petroleum and gas feedstocks) and is a material derived from the incomplete combustion of coal tar, vegetable matter, or petroleum products, including fuel oil, and heavy crude oil.

### Description

As used herein, “micropore” means a pore size of up to 2 nm, and “mesopore” means a pore size between 2 to 50 nm.

Embodiments of the present disclosure relate to a process for treating carbon black with an acidic solution to produce an acidized carbon black for removing polycyclic aromatic hydrocarbons from a crude oil feed. As is described herein, according to embodiments, the process for producing the acidized carbon black for removing polycyclic aromatic hydrocarbons from a crude oil feed may include contacting carbon black with an acidic solution, activating the carbon black, and contacting the activated carbon black with the crude oil feed to remove the polycyclic aromatic hydrocarbons. As is described herein, according to embodiments, the activated carbon black may comprise a mesopore surface area greater than or equal to 1100 m²/g, a micropore surface area less than or equal to 200 m²/g, and a total surface area greater than or equal to 1200 m²/g.

The contacting of carbon black with an acidic solution and activating the acidized carbon black increases the adsorption capacity of the carbon black. Without being bound by any particular theory, it is believed that increasing the adsorption, capacity, selectivity, or carbon framework of the acidized carbon black of the present disclosure can reduce or prevent the frequency of replacing or renewing carbon black and capital costs. Without being bound by any particular theory, it is believed that contacting a crude oil feed with activated carbon black can enable the activated carbon black to remove higher amounts of PAHs from the crude oil feed. The activated carbon black of the present disclosure can achieve higher removal of PAHs from crude oil feeds (>50%), among other features.

In embodiments, the processes of the present disclosure may include contacting carbon black with an acidic solution, the acidic solution comprising water and one or both of nitric acid or phosphoric acid, to produce acidized carbon black, activating the acidized carbon black to produce activated carbon black, and contacting the activated carbon black with the crude oil feed to remove polycyclic aromatic hydrocarbons (PAHs) from the crude oil feed. In embodiments, the activated carbon black may comprise a mesopore surface area greater than or equal to 1100 m²/g, a micropore surface area less than or equal to 200 m²/g, and a total surface area greater than or equal to 1200 m²/g.

Contacting carbon black with a crude oil feed comprising PAHs can remove at least a portion of the PAHs from the crude oil feed. Minimizing PAHs from a crude oil feed can reduce or prevent environmental impact as well as buildup of PAHs in recycled crude oil feeds. Contacting the activated carbon black of the present disclosure with crude oil feeds can increase the removal of PAHs from crude oil feeds as compared to carbon black or activated carbon. Carbon black can be obtained from recycled biomass material or recycled waste tires, which can reduce or prevent excessive processing of activated carbon. Treating carbon black with an acidic solution to produce an acidized carbon black can increase or improve the pore volume of the acidized carbon black and the surface area of the acidized carbon black, as well as reduce or prevent inorganic elements in the acidized carbon black. A larger pore volume and surface area of the acidized carbon black can be essential to the adsorption functions of the acidized carbon black. Reduced inorganic elements in the acidized carbon black can improve or increase the carbon framework, adsorption, and capacity of the acidized carbon black. An acidic solution comprising water and one of nitric acid or phosphoric acid can include more oxygen groups, which can improve or increase the adsorptive capacity and selectivity of the acidized carbon black. Without being bound by any particular theory, it is believed that increasing the adsorption, capacity, selectivity, or carbon framework of the acidized carbon black of the present disclosure can reduce or prevent the frequency of replacing or renewing carbon black and capital costs. Without being bound by any particular theory, it is believed that contacting a crude oil feed with activated carbon black can enable the activated carbon black to remove higher amounts of PAHs from the crude oil feed. The activated carbon black of the present disclosure can achieve higher removal of PAHs from crude oil feeds (>50%), among other features.

Referring to FIG. 1, one embodiment of the adsorption unit 300 of the present disclosure for processing a crude oil feed 220 is schematically depicted. The adsorption unit 300 may comprise first inlet port 310, a second inlet port 320, a heating jacket 340, a crude oil outlet port 350, and a treatment effluent port 360. Carbon black 50 fills the adsorption unit 300. The adsorption unit 300 contacts the carbon black 50 with an acidic solution 150, producing acidized carbon black. After an acid treatment time, the acidic solution 150 is drained from the adsorption unit 300 via treatment effluent port 360. The adsorption unit 300 then contacts water 170 with the acidized carbon black to wash the acidized carbon black, and after a water soak time, the water 170 is passed out of the adsorption unit 300 through the treatment effluent port 360. The pH of the water 170 passing out of treatment effluent port 360 is monitored by a pH indicator, and the adsorption unit 300 continues to contact water 170 with the acidized carbon black until the pH indicator reaches 7±1.

The adsorption unit 300 then contacts dry air 100 with the acidized carbon black to dry the acidized carbon black for a drying time, after which, the dry air 100 is passed out of the adsorption unit 300 through the treatment effluent port 360. The adsorption unit 300 then contacts nitrogen gas 110 with the acidized carbon black to activate the acidized carbon black. The acidized carbon black is contacted with nitrogen gas 110 for an activation time. The adsorption unit 300 is also heated such that the acidized carbon black and the nitrogen gas 100 are heated isothermally via the heating jacket 340 to activate the acidized carbon black. The adsorption unit 300 is heated by the heating jacket 340 for a heating time at an activation temperature. The adsorption unit 300 then contacts the crude oil 220 from a heavy fraction unit 200 with the activated carbon black at a removal temperature. The treated crude oil 220 is passed out of the adsorption unit 300 via the crude oil outlet port 350. The acidic solution, water, dry air, and nitrogen gas enter the adsorption unit 300 through the valve 180 which connects to the first inlet port 310.

The crude oil feed 220 may be a raw hydrocarbon which has not been previously processed, such as through one or more of distillation, cracking, hydroprocessing, desalting, or dehydration. This may be called heavy crude oil. In embodiments, the crude oil feed 220 may have undergone at least some processing, such as desalting, solids separation, scrubbing, desulfurization, or combinations of these, but has not been subjected to separation by boiling point (e.g., distillation). For instance, the crude oil may be a de-salted crude oil that has been subjected to a de-salting process or a hydrotreated crude oil that has been subjected to a hydrotreating process. In embodiments, crude oil may not have undergone pretreatment, separation (such as distillation), or other operation that changes the hydrocarbon composition of the crude oil prior to introducing the crude oil to the process. As used herein, the “hydrocarbon composition” of the crude oil refers to the composition of the hydrocarbon constituents of the crude oil and does not include entrained non-hydrocarbon solids, salts, water, or other non-hydrocarbon constituents. The heavy crude oil may have an American Petroleum Institute (“API”) gravity of from 20° to 35°, such as an API gravity of from 20° to 33°, from 20° to 30°, from 20° to 28°, from 20° to 26°, from 20° to 24°, from 22° to 35°, from 24° to 35°, from 24° to 30°, from 26° to 35°, from 28° to 35°, from 30° to 35°, from 32° to 35°, from 22.5° to 32.5°, from 25° to 30°, or any combination of these ranges. In embodiments, the heavy crude may be an Arab Heavy Crude Oil (a crude oil having an API gravity of approximately) 26.8°.

The acidic solution 150 can comprise of one or both of nitric acid or phosphoric acid. In embodiments, the acidic solution 150 can comprise from 0% to 0.10% phosphoric acid, such as 0.01% to 0.10% phosphoric acid, 0.03% to 0.10% phosphoric acid, 0.05% to 0.10% phosphoric acid, 0% to 0.05% phosphoric acid, 0.01% to 0.05% phosphoric acid, 0.03% to 0.05% phosphoric acid, 0% to 0.03% phosphoric acid, 0.01% to 0.03% phosphoric acid, or 0% to 0.01% phosphoric acid based on the total weight of the acidic solution 150. In embodiments, the acidic solution 150 can comprise from 0% to 15% nitric acid, such as from 1% to 15% nitric acid, from 2.5% to 15% nitric acid, from 5% to 15% nitric acid, from 7.5% to 15% nitric acid, from 10% to 15% nitric acid, from 12.5% to 15% nitric acid, from 0% to 12.5% nitric acid, from 1% to 12.5% nitric acid, from 2.5% to 12.5% nitric acid, from 5% to 12.5% nitric acid, from 7.5% to 12.5% nitric acid, from 10% to 12.5% nitric acid, from 0% to 10% nitric acid, from 1% to 10% nitric acid, from 2.5% to 10% nitric acid, from 5% to 10% nitric acid, from 7.5% to 10% nitric acid, from 0% to 7.5% nitric acid, from 1% to 7.5% nitric acid, from 2.5% to 7.5% nitric acid, from 5% to 7.5% nitric acid, from 0% to 5% nitric acid, from 1% to 5% nitric acid, from 2.5% to 5% nitric acid, from 0% to 2.5% nitric acid, from 1% to 2.5% nitric acid, or from 0% to 1% nitric acid based on the total weigh of the acidic solution 150. The acidic solution 150 can comprise of at least one of distilled water, reverse osmosis water, water, and steamed distilled water.

In embodiments, the acidic solution 150 can have a molarity between 0.01 M to 3.0 M, such as from 0.1 M to 3.0 M, from 0.5 M to 3.0 M, from 1.0 M to 3.0 M, from 1.5 M to 3.0 M, from 2.0 M to 3.0 M, from 2.5 M to 3.0 M, from 0.1 M to 3.0 M, from 0.01 M to 2.5 M, from 0.1 M to 2.5 M, from 0.5 M to 2.5 M, from 1.0 M to 2.5 M, from 1.5 M to 2.5 M, from 2.0 M to 2.5 M, from 0.01 M to 2.0 M, from 0.1 M to 2.0 M, from 0.1 M to 2.0 M, from 0.5 M to 2.0 M, from 1.0 M to 2.0 M, from 1.5 M to 2.0 M, from 0.01 M to 1.5 M, from 0.1 M to 1.5 M, from 0.5 M to 1.5 M, from 1.0 M to 1.5 M, from 0.01 M to 1.0 M, from 0.1 M to 1.0 M, from 0.5 M to 1.0 M, from 0.01 M to 0.5 M, from 0.1 M to 0.5 M, or from 0.01 M to 0.1 M. In embodiments, the adsorption unit 300 contacts the carbon black 50 with acidic solution 150 for an acid treatment time from 0.5 to 24 hours, such as from 1 to 24 hours, from 2 to 24 hours, from 5 to 24 hours, from 10 to 24 hours, from 15 to 24 hours, from 20 to 24 hours, from 0.5 to 20 hours, from 1 to 20 hours, from 2 to 20 hours, from 5 to 20 hours, from 10 to 20 hours, from 15 to 20 hours, from 0.5 to 15 hours, from 1 to 15 hours, from 2 to 15 hours, from 5 to 15 hours, from 10 to 15 hours, from 0.5 to 10 hours, from 1 to 10 hours, from 2 to 10 hours, from 5 to 10 hours, from 0.5 to 5 hours, from 1 to 5 hours, from 2 to 5 hours, from 0.5 to 2 hours, from 1 to 2 hours, or from 0.5 to 1 hours.

The water 170 can comprise one or a combination of distilled water, RO, water, or steamed distilled water. In embodiments, the adsorption unit 300 contacts the acidized carbon black and the water 170 for a water soak time of from 15 to 30 minutes, such as from 20 to 30 minutes, from 25 to 30 minutes, from 15 to 25 minutes, from 20 to 25 minutes, or from 15 to 20 minutes.

In embodiments, the adsorption unit 300 contacts dry air 100 with the acidized carbon black to dry the acidized carbon black for a drying time of from 1 to 12 hours, such as from 2 to 12 hours, from 4 to 12 hours, from 6 to 12 hours, from 8 to 12 hours, from 10 to 12 hours, from 1 to 10 hours, from 2 to 10 hours, from 4 to 10 hours, from 6 to 10 hours, from 8 to 10 hours, from 1 to 8 hours, from 2 to 8 hours, from 4 to 8 hours, from 6 to 8 hours, from 1 to 6 hours, from 2 to 6 hours, from 4 to 6 hours, from 1 to 4 hours, from 2 to 4 hours, or from 1 to 2 hours.

In embodiments, the acidized carbon black is contacted with nitrogen gas 110 for an activation time of from 0.1 to 5.0 hours, such as from 0.5 to 5.0 hours, from 1.0 to 5.0 hours, from 2.0 to 5.0 hours, from 3.0 to 5.0 hours, from 4.0 to 5.0 hours, from 0.1 to 4.0 hours, from 0.5 to 4.0 hours, from 1.0 to 4.0 hours, from 2.0 to 4.0 hours, from 4.0 to 4.0 hours, from 0.1 to 3.0 hours, from 0.5 to 3.0 hours, from 1.0 to 3.0 hours, from 2.0 to 3.0 hours, from 0.1 to 2.0 hours, from 0.5 to 2.0 hours, from 1.0 to 2.0 hours, from 0.1 to 1.0 hours, from 0.5 to 1.0 hours, or from 0.1 to 0.5 hours. The adsorption unit 300, nitrogen gas 110, and acidized carbon black are heated isothermally via the heating jacket 340 to activate the acidized carbon black at a heating temperature from 120 to 500° C., such as from 160 to 500° C., from 180 to 500° C., from 200 to 500° C., from 220 to 500° C., from 250 to 500° C., from 310 to 500° C., from 350 to 500° C., from 390 to 500° C., from 450 to 500° C., from 120 to 450° C., from 160 to 450° C., from 180 to 450° C., from 200 to 450° C., from 220 to 450° C., from 250 to 450° C., from 310 to 450° C., from 350 to 450° C., from 390 to 450° C., from 120 to 390° C., from 160 to 390° C., from 180 to 390° C., from 200 to 390° C., from 220 to 390° C., from 250 to 390° C., from 310 to 390° C., from 350 to 390° C., from 120 to 350° C., from 160 to 350° C., from 180 to 350° C., from 200 to 350° C., from 220 to 350° C., from 250 to 350° C., from 310 to 350° C., from 120 to 310° C., from 160 to 310° C., from 180 to 310° C., from 200 to 310° C., from 220 to 310° C., from 250 to 310° C., from 120 to 250° C., from 160 to 250° C., from 180 to 250° C., from 200 to 250° C., from 220 to 250° C., from 120 to 220° C., from 160 to 220° C., from 180 to 220° C., from 200 to 220° C., from 120 to 200° C., from 160 to 200° C., from 180 to 200° C., from 120 to 180° C., from 160 to 180° C., or from 120 to 160° C.

In embodiments, the adsorption unit 300, nitrogen gas 110, and acidized carbon black is heated isothermally via the heating jacket 340 for a heating time from 1 to 48 hours, such as from 4 to 48 hours, from 8 to 48 hours, from 12 to 48 hours, from 16 to 48 hours, from 20 to 48 hours, from 24 to 48 hours, from 28 to 48 hours, from 32 to 48 hours, from 36 to 48 hours, from 40 to 48 hours, from 44 to 48 hours, from 1 to 44 hours, from 4 to 44 hours, from 8 to 44 hours, from 12 to 44 hours, from 16 to 44 hours, from 20 to 44 hours, from 24 to 44 hours, from 28 to 44 hours, from 32 to 44 hours, from 36 to 44 hours, from 40 to 44 hours, from 1 to 40 hours, from 4 to 40 hours, from 8 to 40 hours, from 12 to 40 hours, from 16 to 40 hours, from 20 to 40 hours, from 24 to 40 hours, from 28 to 40 hours, from 32 to 40 hours, from 36 to 40 hours, from 1 to 36 hours, from 4 to 36 hours, from 8 to 36 hours, from 12 to 36 hours, from 16 to 36 hours, from 20 to 36 hours, from 24 to 36 hours, from 28 to 36 hours, from 32 to 36 hours, from 1 to 32 hours, from 4 to 32 hours, from 8 to 32 hours, from 12 to 32 hours, from 16 to 32 hours, from 20 to 32 hours, from 24 to 32 hours, from 28 to 32 hours, from 1 to 28 hours, from 4 to 28 hours, from 8 to 28 hours, from 12 to 28 hours, from 16 to 28 hours, from 20 to 28 hours, from 24 to 28 hours, from 1 to 24 hours, from 4 to 24 hours, from 8 to 24 hours, from 12 to 24 hours, from 16 to 24 hours, from 20 to 24 hours, from 1 to 20 hours, from 4 to 20 hours, from 8 to 20 hours, from 12 to 20 hours, from 16 to 20 hours, from 1 to 16 hours, from 4 to 16 hours, from 8 to 16 hours, from 12 to 16 hours, from 1 to 12 hours, from 4 to 12 hours, from 8 to 12 hours, from 1 to 8 hours, from 4 to 8 hours, or from 1 to 4 hours.

In embodiments, the adsorption unit 300 contacts the crude oil 220 with the activated carbon black at a removal temperature from 50 to 400° C., such as from 100 to 400° C., from 150 to 400° C., from 200 to 400° C., from 250 to 400° C., from 300 to 400° C., from 350 to 400° C., from 50 to 350° C., from 100 to 350° C., from 150 to 350° C., from 200 to 350° C., from 250 to 350° C., from 300 to 350° C., from 50 to 300° C., from 100 to 300° C., from 150 to 300° C., from 200 to 300° C., from 250 to 300° C., from 50 to 250° C., from 100 to 250° C., from 150 to 250° C., from 200 to 250° C., from 50 to 200° C., from 100 to 200° C., from 150 to 200° C., from 50 to 150° C., from 100 to 150° C., or from 50 to 100° C. The crude oil 220 can be a raw hydrocarbon, such as crude oil, which has not been previously processed through distillation; a crude oil that has undergone some degree of processing, such as desalting or removal of entrained solids, prior to being introduced to the adsorption unit 300 as the crude oil 220; or a combination of both.

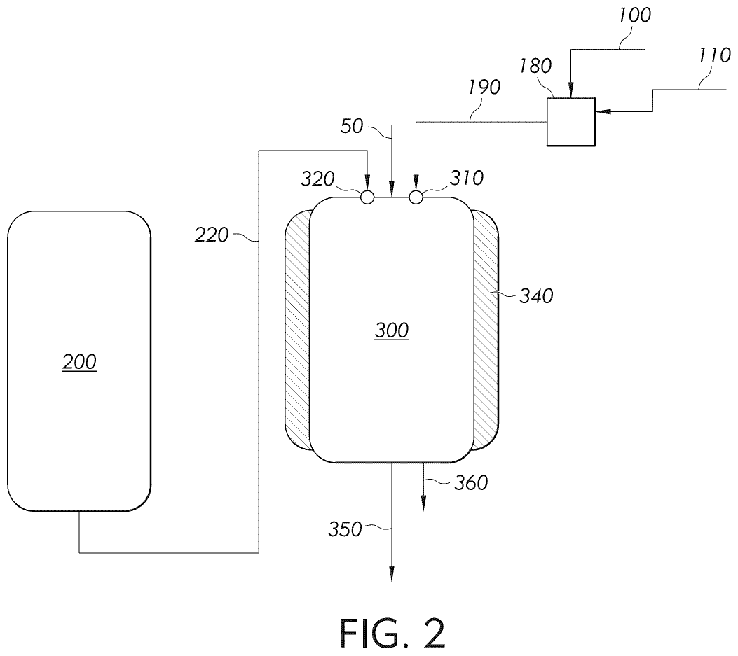

Referring to FIG. 2, one embodiment of the adsorption unit 300 of the present disclosure for processing a crude oil feed 220 is schematically depicted. The adsorption unit 300 may comprise first inlet port 310, a second inlet port 320, a heating jacket 340, a crude oil outlet port 350, and a treatment effluent port 360. The acid treatment and activation of the carbon black 50 occurs outside the adsorption unit 300. The carbon black 50 contacts an acidic solution, producing acidized carbon black. After an acid treatment time, the acidic solution is drained from the acidized carbon black. The acidized carbon black then contacts water to wash the acidized carbon black, and after a water soak time, the water is drained from the acidized carbon black. The pH of the water drained from the acidized carbon black is monitored by a pH indicator, and acidized carbon black continues to contact water until the pH indicator reaches 7±1.

The acidized carbon black then contacts dry air to dry the acidized carbon black for a drying time. The acidized carbon black 50 then fills the adsorption unit 300. The adsorption unit 300 then contacts nitrogen gas 110 with the acidized carbon black to activate the acidized carbon black. The acidized carbon black is contacted with nitrogen gas 100 for an activation time. The adsorption unit 300 is also heated such that the acidized carbon black and the nitrogen gas 100 are heated isothermally via the heating jacket 340 to activate the acidized carbon black. The adsorption unit 300 is heated by the heating jacket 340 for a heating time at an activation temperature. The adsorption unit 300 then contacts the crude oil 220 from a heavy fraction unit 200 with the activated carbon black at a removal temperature. The treated crude oil 220 is passed out of the adsorption unit 300 via the crude oil outlet port 350. The nitrogen gas enters the adsorption unit 300 through the valve 180 which connects to the first inlet port 310.

In embodiments, the adsorption unit 300 can be one of a fixed-bed adsorption unit, batch process unit, or cartridge system.

### EXAMPLES

The various aspects of the present disclosure will be further clarified by the following examples. The examples are illustrative in nature and should not be understood to limit the subject matter of the present disclosure. In the Examples of the present disclosure, the acidized carbon black was treated with an acidic solution comprising one of 2 M nitric acid or 5 M nitric acid. Prior to analysis, all carbon samples were pretreated by heating in an oven at 80° C. for at least two hours.

### Example 1

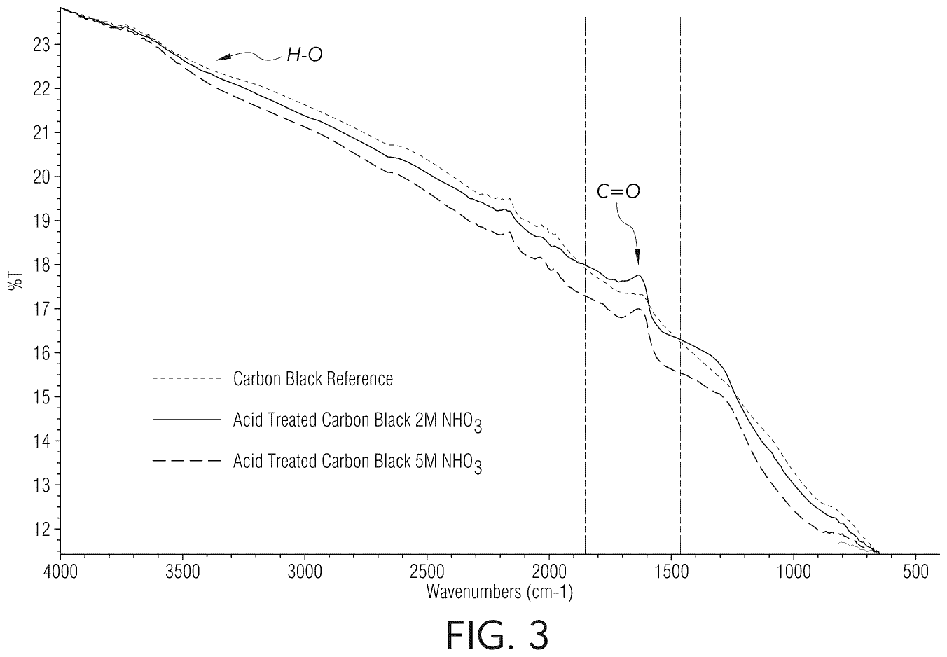

The acid treated carbon black was analyzed with Fourier-transform infrared spectroscopy (FTIR) after calcination at 500° C. The purpose of the analysis was to determine the functional groups introduced upon chemical treatment. Referring now to FIG. 3, the FTIR spectra of the acid treated carbon black and original carbon black are depicted. FIG. 3 depicts a carbon-oxygen double bond (C═O) stretching band from 1760-1690 cm⁻¹ for the acid treated carbon black samples, thereby denoting the presence of a carbonyl functional group in the acid treated carbon black. The carbonyl functional group is created by the acid treatment. The C═O stretching band was not observed in the original carbon black reference, indicating a successful oxidation and formation of carbonyl group in the carbon black framework samples. The original carbon black reference was obtained from Cabot Corporations.

### Example 2

The surface area, micropore surface, and mesopore surface area of both original carbon black and acidized carbon black were analyzed using a nitrogen adsorption method via Micromeritics ASAP 2020. Table 1 compares the total surface area of the acidized carbon blacks and the original carbon black. The acidized carbon blacks show an improvement in the mesopore surface area, demonstrating an increase in capacity to adsorb PAHs from a crude oil feed. Additionally,

TABLE 1
Surface Area of Modified Carbon Black

| | Total | Micropore | Mesopore |
|---|---|---|---|
| | Surface | surface | surface |
| | area | area | area |
| | units | | |
| Sample | m²/g | m²/g | m²/g |
| Original carbon black | 1402.2 | 466.5 | 935.7 |
| Carbon black treated by the 2M acidic | 1292.2 | 119.8 | 1172.4 |
| solution | | | |
| Carbon black treated by the 5M acidic | 1338.1 | 94.0 | 1244.1 |
| solution | | | |

### Example 3

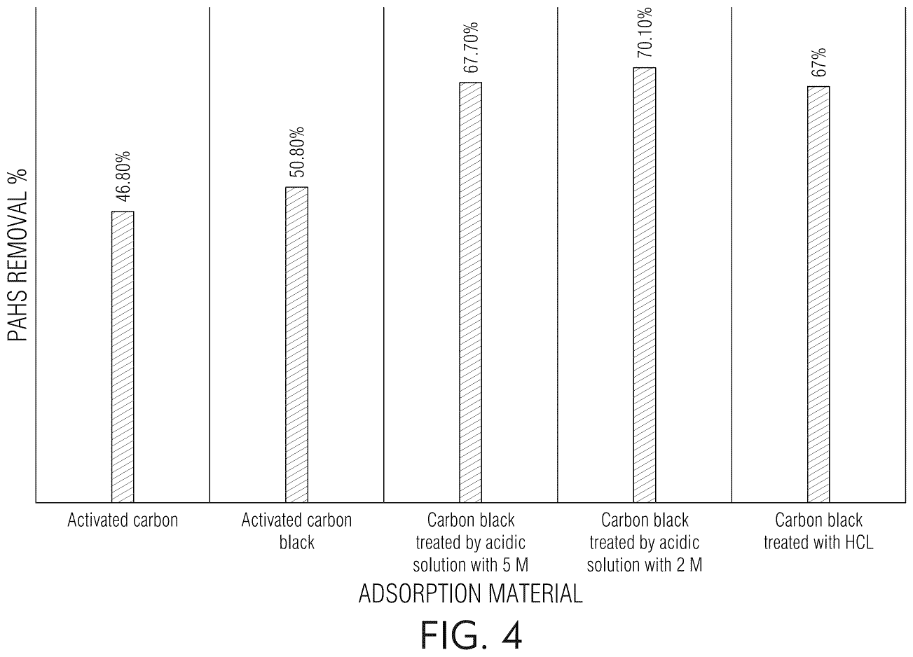

The adsorption capacity of acidized carbon black was evaluated and compared with non-acidized activated carbon black and activated carbon. The activation of these comparative samples was performed by placing the samples in placing the samples in an oven at 80° C. for more than 2 hours. The acidized carbon blacks and the original carbon black were contacted with a feedstock comprising of a solution of 520 ppm anthracene (a PAH) in dodecane. The feedstock to adsorption material ratio was 200 to 1. The feedstock and adsorption materials were mixed for 24 hours. The equilibrium concentration of anthracene was quantified with gas chromatography flame ionization detector (GC-FID). The results showed that acidized carbon black have a better PAH removal capacity, the 5 M nitric acid acidized carbon black removing 16.9-20.9% more PAHs and the 2 M nitric acid acidized carbon black removing 19.3-23.3% more PAHs than the original carbon black. The results are also graphically depicted in FIG. 4.

TABLE 2
PAH Removal Percentage for Carbon Blacks

| Carbon adsorption material | PAHs Removal % |
|---|---|
| Activated carbon (original) | 46.8% |
| Non-acidized activated carbon black (original) | 50.8% |
| Carbon black treated by acidic solution with 5M | 67.7% |
| Carbon black treated by acidic solution with 2M | 70.1% |
| Carbon black treated with HCl | 67% |

According to at least one aspect of the present disclosure, a process for removing polycyclic aromatic hydrocarbons from a crude oil feed comprises contacting carbon black with an acidic solution to produce acidized carbon black. The acidic solution includes water and one or both of nitric acid or phosphoric acid. The process additionally comprises activating the acidic treated carbon black by contacting it with nitrogen in an adsorption vessel and heating the adsorption vessel to 120 to 500° C., producing activated carbon black. The process further comprises removing the polycyclic aromatic hydrocarbons from the crude oil feed by contacting the activated carbon black with the crude oil feed in the adsorption vessel.

It is noted that any two quantitative values assigned to a property may constitute a range of that property, and all combinations of ranges formed from all stated quantitative values of a given property are contemplated in this disclosure.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific aspects, it is noted that the various details of such aspects should not be taken to imply that these details are essential components of the aspects. Rather, the claims appended hereto should be taken as the sole representation of the breadth of the present disclosure and the corresponding scope of the various aspects described in this disclosure. Further, it will be apparent that modifications and variations are possible without departing from the scope of the appended claims.

What is claimed is:

1. A process for removing polycyclic aromatic hydrocarbons from a crude oil feed, the process comprising:
contacting carbon black with an acidic solution to produce acidized carbon black, wherein the acidic solution comprises water and one or both of nitric acid or phosphoric acid;
producing activated carbon black by contacting the acidic treated carbon black with nitrogen in an adsorption vessel and heating the adsorption vessel to a temperature from 120 to 500° C.; and
removing the polycyclic aromatic hydrocarbons from the crude oil feed by contacting the activated carbon black with the crude oil feed in the adsorption vessel.

2. The process of claim 1, wherein the acidic solution contacts the carbon black inside of the adsorption vessel.

3. The process of claim 2, further comprising removing the acidic solution from the adsorption vessel with washing water prior to activation of the acidic treated carbon black.

4. The process of claim 3, further comprising contacting the acidic treated carbon black with dry air inside the adsorption vessel.

5. The process of claim 1, wherein the acidic solution contacts the carbon black outside of the adsorption vessel.

6. The process of claim 5, further comprising removing the acidic solution with washing water outside of the adsorption vessel and prior to activation of the acidic treated carbon black.

7. The process of claim 6, further comprising contacting the acidic treated carbon black with dry air outside of the adsorption vessel.

8. The process of claim 7, transporting the acidic treated carbon black to the adsorption vessel after the drying step.

9. The process of claim 1, wherein the acidic solution comprises only nitric acid.

10. The process of claim 1, wherein the acidic solution comprises both nitric acid and phosphoric acid.

11. The process of claim 1, wherein the step of producing the activated carbon black is isothermal.

12. The process of claim 1, wherein the step of producing the activated carbon black occurs for greater than or equal to 1 hour and less than or equal to 48 hours.

13. The process of claim 1, wherein the activated carbon black has a mesopore surface area of greater than or equal to 1100 m²/g.

14. The process of claim 1, wherein the activated carbon black has a micropore surface area of less than or equal to 200 m²/g.

15. The process of claim 1, wherein the activated carbon black has a mesopore to micropore ratio from 8:1 to 16:1.

16. The process of claim 1, wherein the activated carbon black has a mesopore to micropore ratio from 1:1 to 4:1.

17. The process of claim 1, wherein the activated carbon black adsorbs greater than 65% of the polycyclic aromatic hydrocarbons from the crude oil feed.

18. The process of claim 1, wherein the adsorption vessel is a fixed bed adsorption vessel.
